(19) United States
(12) Patent Application Publication
(10) Pub. No.: US 2015/0234937 A1
(43) Pub. Date: Aug. 20, 2015

(54) INFORMATION RETRIEVAL SYSTEM, INFORMATION RETRIEVAL METHOD AND COMPUTER-READABLE MEDIUM

(71) Applicant: NEC CORPORATION, Minato-ku, Tokyo (JP)

(72) Inventor: Yoshifumi Onishi, Tokyo (JP)

(73) Assignee: NEC Corporation, Minato-ku, Tokyo (JP)

(21) Appl. No.: 14/429,801

(22) PCT Filed: Sep. 12, 2013
(86) PCT No.: PCT/JP2013/005401

§ 371 Date: Mar. 20, 2015

(30) Foreign Application Priority Data
Sep. 27, 2012 (JP) 2012-214952

(51) Int. Cl. G06F 17/30

(52) U.S. Cl. CPC G06F 17/30976; G06F 17/30985; G06F 17/30867

(57) ABSTRACT

An information retrieval system including: a calculating unit which calculates a query language model that is a language model of an input word or of a set of input words; an extracting unit which refers to a storage means storing a result of speech recognition on speech data which is speech-recognized with use of a speech recognition language model, and extracting a result indicating a high degree of similarity to the query language model from the result, as matching data; a first updating unit which updates the speech recognition language model with use of the matching data; and a second updating unit which updates the result stored in the storage means, with use of the updated speech recognition language model, wherein the extracting means extracts a result indicating a high degree of similarity to the query language model from the updated result, and outputs a retrieval result indicating data associated with the extracted result.

This application is a National Stage Entry of PCT/JP2013/005401 filed on Sep. 12, 2013, which claims priority from Japanese Patent Application 2012-214952 filed on Sep. 27, 2012, the contents of all of which are incorporated herein by reference, in their entirety.

### TECHNICAL FIELD

The present invention relates to an information retrieval system, an information retrieval method and a computer-readable medium, and more particularly to an information retrieval system, an information retrieval method and a computer-readable medium storing a program for retrieving data relating to speech.

### BACKGROUND ART

An example of the technique for retrieving data relating to speech is described in Patent Literature (PTL) 1. The retrieval apparatus described in PTL 1 calculates a degree of similarity between text of an input query and text of a speech recognition result, with use of a degree of reliability on speech recognition, and outputs a speech recognition result having a high degree of similarity, as a retrieval result. Generally, a speech recognition result includes misrecognition. The retrieval apparatus eliminates a speech recognition result having a low degree of reliability from a retrieval result, with use of a degree of reliability with respect to the speech recognition result so as to reduce a probability with which a misrecognition result may be output as a retrieval result.

### CITATION LIST

### Patent Literature

Japanese Laid-open Patent Publication No. 2011-248107

### SUMMARY OF INVENTION

### Technical Problem

The technique described in PTL 1 has a problem such that it is difficult to precisely retrieve data relating to speech, when a word that is less recognizable as a speech recognition result is included in a query.

For instance, when a language model such as N-gram is used in speech recognition, a word with a low frequency of appearance in learning a language model is also less recognizable as a speech recognition result. Further, such a word has a low probability value in a language model. Therefore, even when such a word appears in a speech recognition result, the speech recognition result may have a low degree of reliability. In view of the above, when a query relating to such a word is input, it is impossible to precisely retrieve data relating to speech.

### Object of Invention

In view of the above, an object of the invention is to provide an information retrieval system, an information retrieval method, and a computer-readable medium, which are able to solve the above problem and to precisely retrieve data relating to speech, even when a word that is less recognizable as a recognition result is included in a query.

### Solution to Problem

The present invention is an information retrieval system including: a calculating unit which calculates a query language model that is a language model of an input word or of a set of input words; an extracting unit which refers to a storage means storing a result of speech recognition on speech data which is speech-recognized with use of a speech recognition language model, and extracting a result indicating a high degree of similarity to the query language model from the result, as matching data; a first updating unit which updates the speech recognition language model with use of the matching data; and a second updating unit which updates the result stored in the storage means, with use of the updated speech recognition language model, wherein the extracting means extracts a result indicating a high degree of similarity to the query language model from the updated result, and outputs a retrieval result indicating data associated with the extracted result.

The present invention is an information retrieval method including: calculating a query language model that is a language model of an input word or of a set of input words; referring to a storage means storing a speech recognition result on speech data which is speech-recognized with use of a speech recognition language model, and extracting a result indicating a high degree of similarity to the query language model from the result, as matching data; updating the speech recognition language model with use of the matching data; updating the result stored in the storage means, with use of the updated speech recognition language model, and extracting a result indicating a high degree of similarity to the query language model from the updated result, and outputting a retrieval result indicating data associated with the extracted result.

The present invention is a non-transitory computer-readable medium storing a program for an information retrieval system, which causes a computer to execute: calculating a query language model that is a language model of an input word or of a set of input words; referring to a storage means storing a speech recognition result on speech data which is speech-recognized with use of a speech recognition language model, and extracting a result indicating a high degree of similarity to the query language model from the result, as matching data; updating the speech recognition language model with use of the matching data; updating the result stored in the storage means, with use of the updated speech recognition language model; and extracting a result indicating a high degree of similarity to the query language model from the updated result, and outputting a retrieval result indicating data associated with the extracted result.

### Advantageous Effects of Invention

According to the invention, it is possible to precisely retrieve data relating to speech, even when a word that is less recognizable as a speech recognition result is included in a query.

### BRIEF DESCRIPTION OF DRAWINGS

FIG. 1 is a diagram illustrating a hardware configuration according to a first exemplary embodiment of the invention;

FIG. 2 is a block diagram according to the first exemplary embodiment of the invention;

FIG. 3 is a flowchart according to the first exemplary embodiment of the invention;

FIG. 4 is a block diagram according to a second exemplary embodiment of the invention;

FIG. 5 is a flowchart according to the second exemplary embodiment of the invention;

FIG. 6 is a block diagram according to a third exemplary embodiment of the invention;

FIG. 7 is a flowchart according to the third exemplary embodiment of the invention;

FIG. 8 is a block diagram according to a fourth exemplary embodiment of the invention;

FIG. 9 is a flowchart according to the fourth exemplary embodiment of the invention;

FIG. 10 is a block diagram according to an example of the invention;

FIG. 11 is a flowchart according to the example of the invention; and

FIG. 12 is a block diagram illustrating a configuration of an information retrieval system of the invention.

### DESCRIPTION OF EMBODIMENTS

Exemplary embodiments of the invention are described in detail referring to the drawings.

### First Exemplary Embodiment

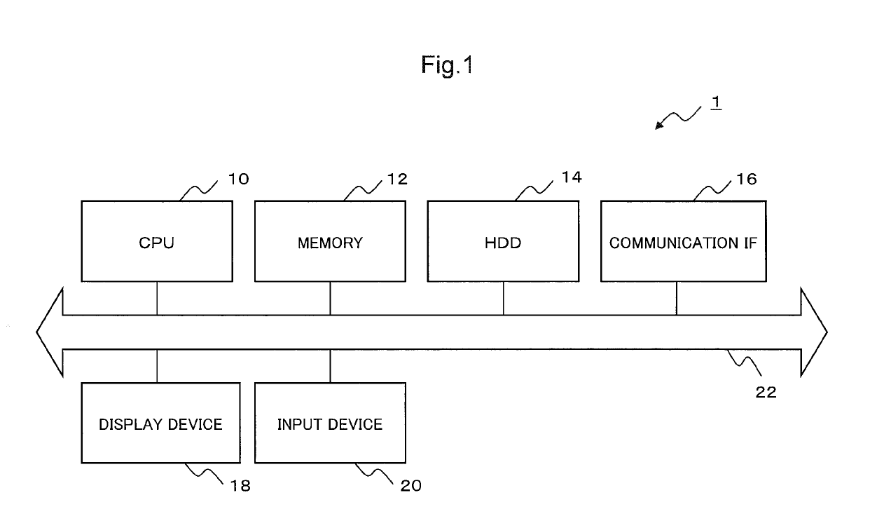

FIG. 1 is a diagram illustrating a hardware configuration of an information retrieval system 1 according to a first exemplary embodiment of the invention. As illustrated in FIG. 1, the information retrieval system 1 includes a CPU 10, a memory 12, a hard disk drive (HDD) 14, a communication interface (IF) 16 which communicates data via an unillustrated network, a display device 18 such as a display, and an input device 20 including a keyboard, and a pointing device such as a mouse. These constituent elements are connected to each other via a bus 22 for inputting and outputting data between the constituent elements. The hardware configuration of the information retrieval system 1 is not limited to the above configuration, and may be modified, as necessary.

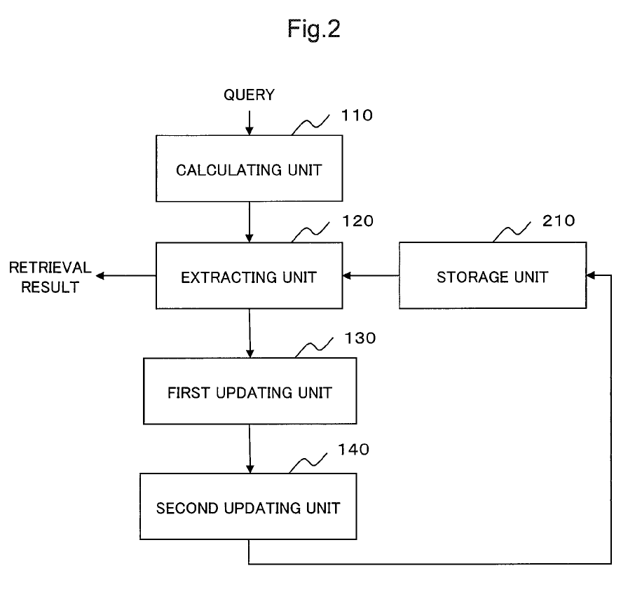

FIG. 2 is a block diagram illustrating a configuration of the information retrieval system according to the first exemplary embodiment of the invention.

As illustrated in FIG. 2, the information retrieval system according to the first exemplary embodiment includes a calculating unit 110, an extracting unit 120, a first updating unit 130, a second updating unit 140, and a storage unit 210.

The storage unit 210 stores a result obtained by speech recognition of speech data with use of a speech recognition language model (hereinafter, called as a speech recognition result). The speech recognition language model is a model, in which constraints of a word string to be recognized are defined in recognizing a speech signal as the word string. The storage unit 210 stores a speech recognition result on a speech data file in the form of a text file. The storage unit 210 stores at least one or more speech recognition results (text files).

The calculating unit 110 calculates a query language model, based on an input query. The query is a word or a set of words to be retrieved.

Next, an example of a method for calculating a query language model is described. The calculating unit 110 calculates a query language model by equation 1. In the equation 1, the query language model is a unigram probability value p(w|θ_{Q}) with respect to a word set of a query, where Q denotes a word set of a query, |Q| denotes the number of words of Q, w denotes a word, and θ_{Q} denotes a parameter of a query language model. Further, n(w,Q) denotes a function such that the function becomes the number of w included in Q, when w is a word included in Q, and the function becomes zero when w is not included in Q.

$$p ( w \vert {θ}_{Q} ) = \frac{n ( w , Q )}{\vert Q \vert} \qquad [ Eq . 1 ]$$

The extracting unit 120 calculates a degree of similarity between a query language model calculated by the calculating unit 110, and each of the speech recognition results (each of the text files) stored in the storage unit 210, and extracts a speech recognition result (a text file) having a high degree of similarity, as matching data.

Next, an example of the extracting method to be performed by the extracting unit 120 is described. The extracting unit 120 calculates a KL (Kullback-Leibler) distance between a query language model and a language model of a speech recognition result, as a degree of similarity by the equation 2. The KL distance is a metric representing a difference between two language models as probability distributions. The smaller the value of KL distance is, the higher the degree of similarity between the two language models is. KL(θ_{Q}∥θ_{D}) denotes a KL distance, and p(w|θ_{D}) denotes a language model of each individual speech recognition result D, which is stored in the storage unit 210.

$$KL ( {θ}_{Q} \vert \vert {θ}_{D} ) = {\sum }_{w ∈ Q} p ( w \vert {θ}_{Q} ) In \frac{p ( w \vert {θ}_{Q} )}{p ( w \vert {θ}_{D} )} \qquad [ Eq . 2 ]$$

The extracting unit 120 calculates a language model p(w|θ_{D}) of a speech recognition result by the equation 3. p(w|θ_{C}) denotes a language model of a universal set C of the speech recognition results stored in the storage unit 210. |D| denotes the number of words constituting a speech recognition result D, and μ denotes a smoothing parameter between unigram probability value of a speech recognition result D and p(w|θ_{C}). For instance, μ is given in advance. Further, the extracting unit 120 calculates p(w|θ_{C}), while using N-gram probability where N is 3 or 4, for instance, with use of the whole of the speech recognition results stored in the storage unit 210.

$$p ( w \vert {θ}_{D} ) = \frac{1}{\vert D \vert + μ} n ( w , D ) + \frac{μ}{\vert D \vert + μ} p ( w \vert {θ}_{C} ) \qquad [ Eq . 3 ]$$

Next, the extracting unit 120 extracts a speech recognition result whose calculated KL distance is smaller than a predetermined threshold value, or is not larger than the threshold value, for instance. Alternatively, the extracting unit 120 may extract a predetermined number of speech recognition results in the ascending order of the KL distance.

The first updating unit 130 updates the speech recognition language model, with use of the matching data extracted by the extracting unit 120 and representing a speech recognition result having a high degree of similarity to the query language model.

The first updating unit 130 updates the speech recognition language model by the equation 5, for instance. In the equation 5, p(w|θ_{ASR}) denotes a speech recognition language model before updating, and p(w|θ′_{ASR}) denotes a speech recognition language model after updating. Further, p(w|θ_{CF}) denotes a language model of a matching data set CF. □ is a parameter for use in updating, and is given in advance, for instance.

p(w|θ′_{ASR})=(1−β)p(w|θ_{CF})+βp(w|θ_{ASR}) [Eq. 5]

The second updating unit 140 updates the speech recognition result stored in the storage unit 210, with use of the speech recognition language model updated by the first updating unit 130. For instance, the second updating unit 140 speech-recognizes speech data again, which is original data of a speech recognition result, with use of the updated speech recognition language model so as to update the speech recognition result stored in the storage unit 210.

Alternatively, the second updating unit 140 may update the result by the following method. The storage unit 210 stores a word graph associated with the speech recognition result, as well as the speech recognition result on speech data which is speech-recognized with use of the speech recognition language model before updating. Further alternatively, the word graph may be stored in a storage unit other than the storage unit 210. The second updating unit 140 rescores a language probability with respect to the word graph, with use of the updated speech recognition language model so as to update the speech recognition result stored in the storage unit 210.

The extracting unit 120 calculates a degree of similarity between the query language model calculated by the calculating unit 110, and the updated speech recognition result stored in the storage unit 210, and extracts a speech recognition result having a high degree of similarity, as matching data.

Further, when a condition for outputting a retrieval result is satisfied, the extracting unit 120 outputs at least a part of data associated with the extracted speech recognition result, as a retrieval result. The condition for outputting a retrieval result is, for instance, such that updating a speech recognition language model, updating a result stored in the storage unit 210, and extracting matching data have been performed a predetermined number of times. Further, the condition for outputting a retrieval result may be such that a speech recognition result extracted from the updated speech recognition result coincides with a speech recognition result extracted from the speech recognition result before updating. In other words, the condition is such that a speech recognition result to be extracted does not change any more. Data associated with a speech recognition result may be a speech recognition result itself. Further, data associated with a speech recognition result may be speech data, which is original data of a speech recognition result.

The operations of the calculating unit 110, the extracting unit 120, the first updating unit 130, and the second updating unit 140 are not limited to the above example, but may be modified, as necessary.

Next, an operation of the first exemplary embodiment for carrying out the invention is described in detail.

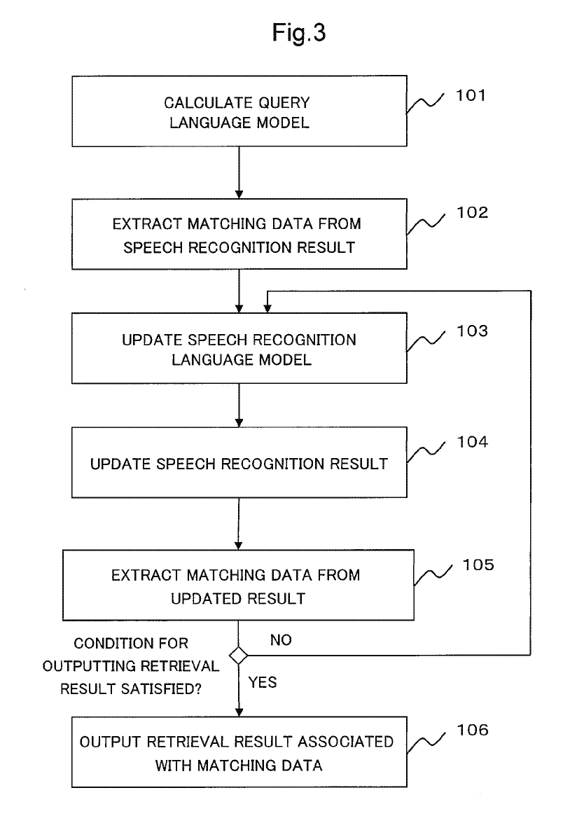

FIG. 3 is a flowchart illustrating an example of an operation of the first exemplary embodiment.

In Step 101, the calculating unit 110 calculates a query language model, based on an input query. In Step 102, the extracting unit 120 calculates a degree of similarity between the query language model calculated by the calculating unit 110, and a speech recognition result stored in the storage unit 210, and extracts a speech recognition result having a high degree of similarity, as matching data. In Step 103, the first updating unit 130 updates a speech recognition language model, with use of the matching data extracted by the extracting unit 120. In Step 104, the second updating unit 140 updates the speech recognition result stored in the storage unit 210, with use of the updated speech recognition language model. In Step 105, the extracting unit 120 calculates a degree of similarity between the query language model calculated by the calculating unit 110, and the updated speech recognition result stored in the storage unit 210, and extracts a speech recognition result having a high degree of similarity, as matching data. When the condition for outputting a retrieval result is not satisfied, the process returns to Step 103. When the condition for outputting a retrieval result is satisfied, in Step 106, the extracting unit 120 outputs at least a part of a retrieval result associated with the extracted speech recognition result.

According to the exemplary embodiment, a speech recognition language model is updated, using a speech recognition result having a high degree of similarity to a word set input as a query. Further, a speech recognition result stored in the storage unit 210 is updated by the updated speech recognition language model. Therefore, the information retrieval system according to the exemplary embodiment is capable of appropriately giving a probability value for a speech recognition language model, and a degree of reliability for a speech recognition result, with respect to a word included in a query. Thus, it is possible to precisely retrieve data relating to speech, when a word that is less recognizable as a recognition result is included in a query.

### Second Exemplary Embodiment

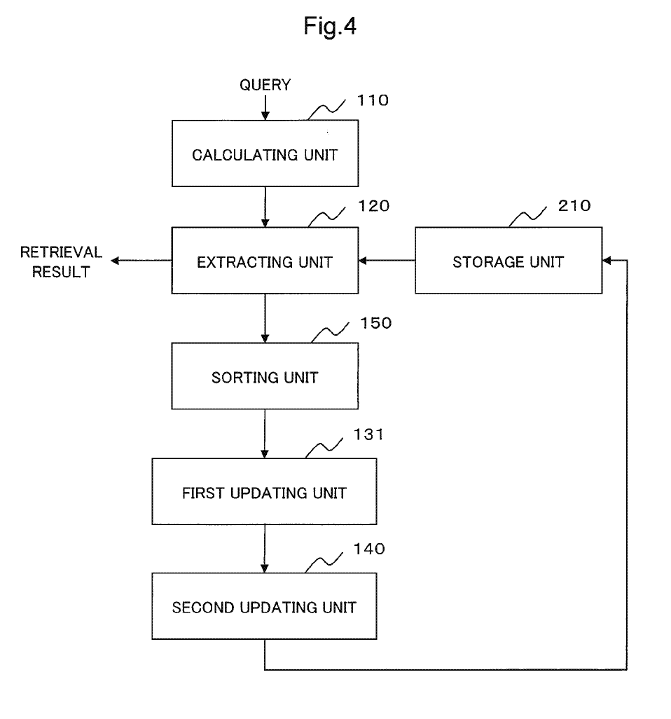

FIG. 4 is a block diagram illustrating a configuration of an information retrieval system according to a second exemplary embodiment of the invention.

The information retrieval system according to the second exemplary embodiment includes a sorting unit 150, in addition to the constituent elements of the first exemplary embodiment. Further, the information retrieval system according to the second exemplary embodiment includes a first updating unit 131, in place of the first updating unit 130 of the first exemplary embodiment. The constituent elements of the second exemplary embodiment other than the sorting unit 150 and the first updating unit 131 are the same as those of the first exemplary embodiment, and therefore, description thereof is omitted.

The sorting unit 150 sorts matching data elements, based on a degree of similarity between the matching data elements. Specifically, the sorting unit 150 eliminates, from matching data, matching data elements whose degrees of similarity to the other matching data elements are low.

The sorting unit 150 sorts matching data elements as follows, for instance. The sorting unit 150 calculates a language model p(w|θ_{CF}) of a matching data set CF. p(w|θ_{CF}) denotes N-gram probability value, where N is, for instance, 1 or 2. Subsequently, the sorting unit 150 calculates a language model p(w|θ_{F}) of matching data F included in the matching data set CF by the equation 6. |F| denotes the number of words constituting matching data F, and □ denotes a smoothing parameter between p(w|θ_{CF}) and uni-gram probability value of matching data F. □ may be given in advance.

$$p ( w \vert {θ}_{F} ) = \frac{1}{\vert F \vert + σ} n ( w , F ) + \frac{σ}{\vert F \vert + σ} p ( w \vert {θ}_{CF} ) \qquad [ Eq . 6 ]$$

The sorting unit 150 calculates KL(θ_{CF}∥θ_{F}), which is a KL distance between matching data set CF and matching data F, and eliminates a document whose value of KL distance is larger than a predetermined value. The method for calculating a KL distance is the same as the equation 2, and therefore, description of the method is omitted.

Alternatively, the sorting unit 150 may sort matching data elements as follows. The sorting unit 150 calculates each language model of matching data elements F1 and F2 included in the matching data set CF by the equation 6. It is assumed that the language model of F1 is represented by P(w|θ_{F1}), and the language model of F2 is represented by P(w|θ_{F2}). Subsequently, the sorting unit 150 calculates SKL(θ_{F1},θ_{F2}), which is a degree of similarity of F1 and F2 by the equation 7.

$$SKL ( {θ}_{F 1} , {θ}_{F 2} ) = \frac{KL ( {θ}_{F 1} \vert \vert {θ}_{F 2} ) + KL ( {θ}_{F 2} \vert \vert {θ}_{F 1} )}{2} \qquad [ Eq . 7 ]$$

Further, the sorting unit 150 performs bottom-up clustering, based on SKL(θ_{F1},θ_{F2}). Bottom-up clustering is a technique of successively and hierarchically sorting the neighboring pairs of data elements until a designated number of clusters is obtained. The sorting unit 150 eliminates, from matching data, data elements included in clusters other than a main cluster. The main cluster is, for instance, a cluster having a largest number of matching data elements belonging to the clusters. Alternatively, the main cluster may be a designated number of clusters counted up in the descending order of the number of matching data elements belonging to the clusters.

The first updating unit 131 updates a speech recognition language model, with use of matching data elements sorted by the sorting unit 150. The method for updating a model is the same as the method to be performed by the first updating unit 130, and therefore, description of the method is omitted.

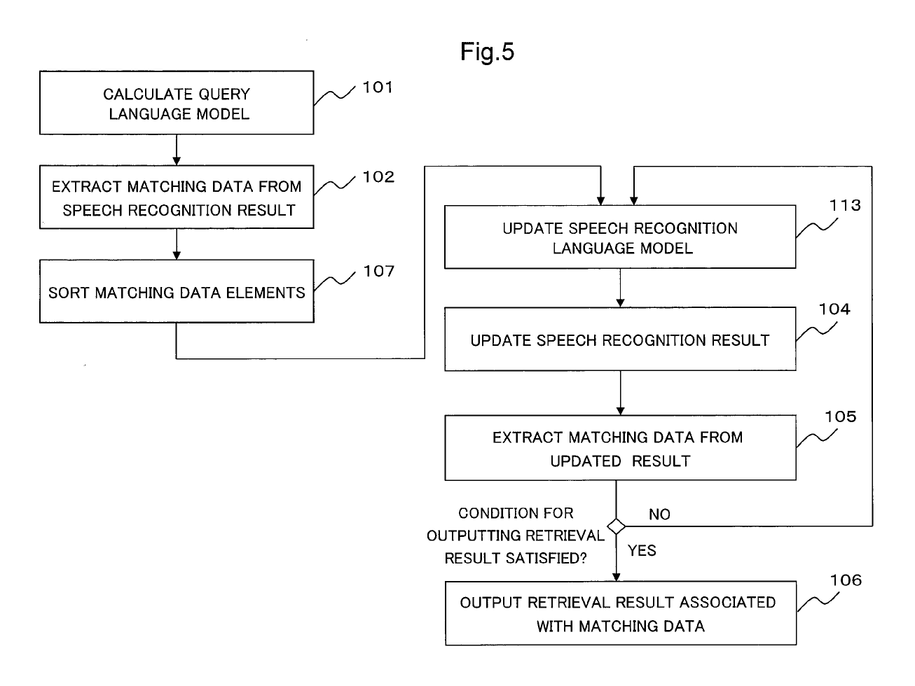

FIG. 5 is a flowchart illustrating an example of an operation of the second exemplary embodiment. Steps 101 and 102 are the same operations as those in the first exemplary embodiment, and therefore, description thereof is omitted. In Step 107, the sorting unit 150 sorts the matching data elements. In Step 113, the first updating unit 131 updates a speech recognition result, with use of the sorted matching data elements. Steps 104 to 106 are the same operations as those in the first exemplary embodiment, and therefore, description thereof is omitted.

The information retrieval system according to the exemplary embodiment eliminates, from matching data, matching data elements whose degrees of similarity to the other matching data elements are low. Therefore, the information retrieval system is capable of eliminating an inappropriate matching data element that may be inadvertently included in matching data, based on a degree of similarity between matching data elements, taking into consideration a word that is not included in a word set of a query. Thus, the information retrieval system is more robust with respect to speech misrecognition.

### Third Exemplary Embodiment

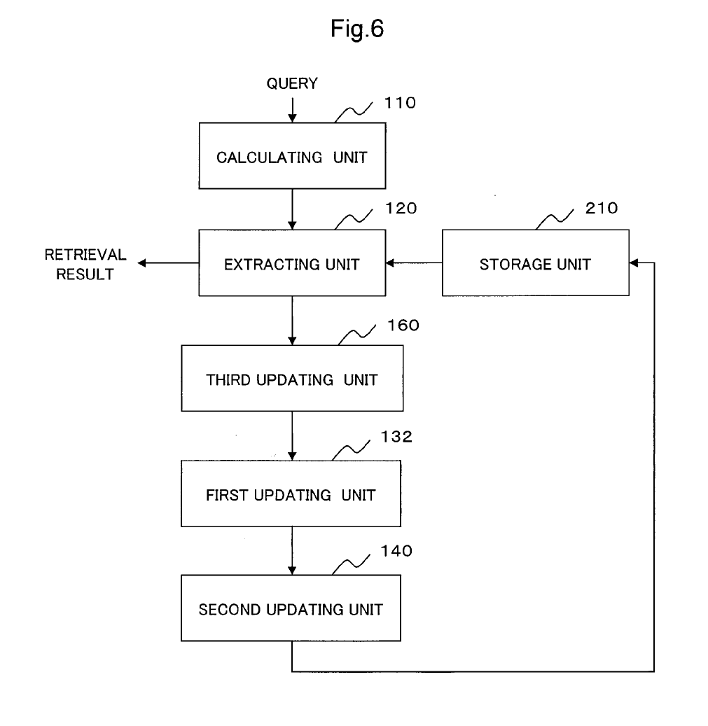

FIG. 6 is a block diagram illustrating a configuration of an information retrieval system according to a third exemplary embodiment of the invention.

The information retrieval system according to the third exemplary embodiment includes a third updating unit 160, in addition to the constituent elements of the first exemplary embodiment. Further, the information retrieval system according to the third exemplary embodiment includes a first updating unit 132, in place of the first updating unit 130 of the first exemplary embodiment. The constituent elements of the third exemplary embodiment other than the third updating unit 160 and the first updating unit 132 are the same as those of the first exemplary embodiment, and therefore, description thereof is omitted.

The third updating unit 160 updates a query language model, with use of matching data extracted by an extracting unit 120. For instance, the third updating unit 160 updates a query language model by the equation 8. p(w|θ_{Q}) denotes a query language model before updating. p(w|θ′_{Q}) denotes a query language model after updating.

p(w|θ′_{Q})=(1−α)p(w|θ_{Q})+αp(w|θ_{CF}) [Eq. 8]

p(w|θ_{CF}) denotes a language model of a matching data set CF, and □ denotes a smoothing parameter between p(w|θ_{Q}) and p(w|θ_{CF}). □ may be given in advance.

The first updating unit 132 updates a speech recognition language model, with use of the query language model updated by the third updating unit 160 by the equation 9. The equation 9 is an equation, in which p(w|θ_{CF}) in the equation 5 is substituted by p(w|θ′_{Q}).

p(w|θ′_{ASR})=(1−β)p(w|θ′_{Q})+βp(w|θ_{ASR}) [Eq. 9]

A method for updating a query language model is also described in Non Patent Literature (NPL) 1.

[NPL 1] ChengXiang Zhai, “Statistical Language Models for Information Retrieval A Critical Review”, Foundations and Trends in Information Retrieval, Vol. 2, No. 3 (2008) 137-213

The technique described in NPL 1 is an example of the technique for retrieving a text document. The information retrieval system of the invention retrieves data relating to speech. The information retrieval system of the invention updates a speech recognition language model and a speech recognition result, using the updated query language model. In other words, the information retrieval system of the invention uses a feature that a speech recognition result changes depending on a language model for use in speech recognition.

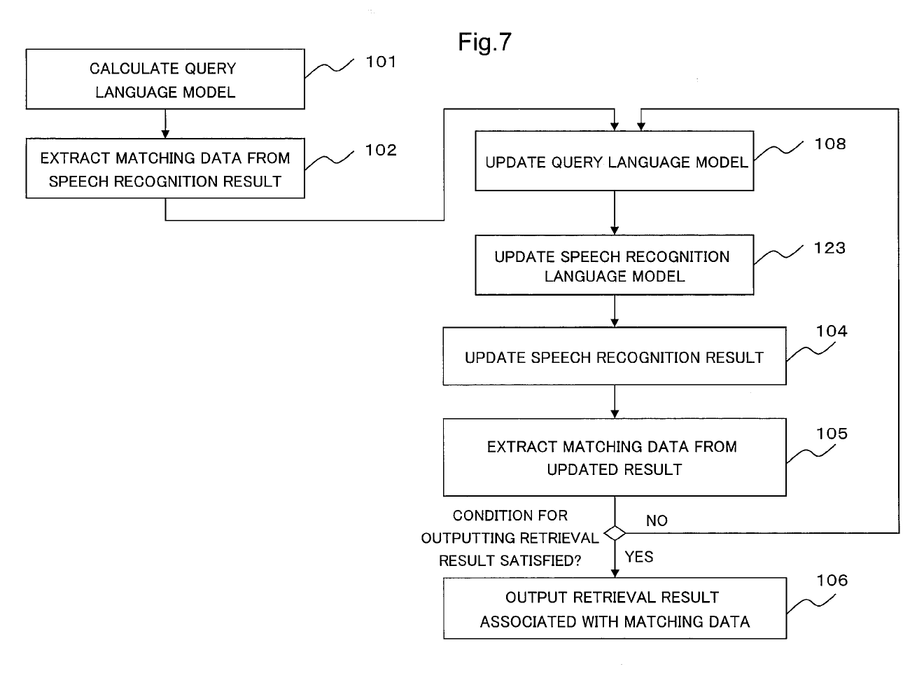

FIG. 7 is a flowchart illustrating an example of an operation of the third exemplary embodiment. Steps 101 and 102 are the same operations as those in the first exemplary embodiment, and therefore, description thereof is omitted. In Step 108, the third updating unit 160 updates a query language model, with use of matching data extracted by the extracting unit 120. In Step 123, the first updating unit 132 updates a speech recognition language model, with use of the query language model updated by the third updating unit 160. Steps 104 to 106 are the same operations as those in the first exemplary embodiment, and therefore, description thereof is omitted.

The information retrieval system according to the exemplary embodiment is capable of precisely retrieving data relating to speech. A query language model is updated based on matching data. Further, a speech recognition language model is also updated by the updated query language model. Thus, the query language model and the speech recognition language model are consistently updated.

### Fourth Exemplary Embodiment

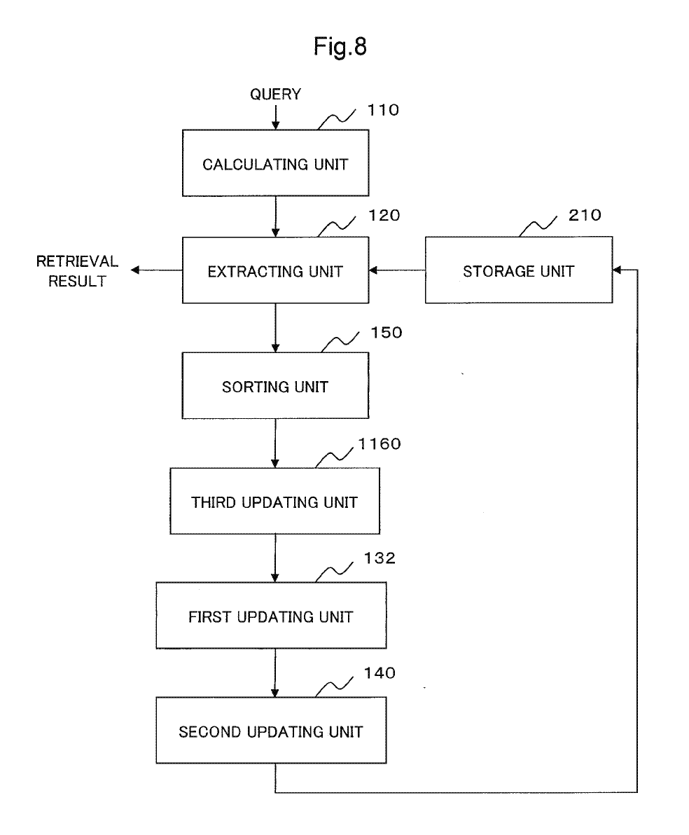

FIG. 8 is a block diagram illustrating a configuration of an information retrieval system according to a fourth exemplary embodiment of the invention. The exemplary embodiment is a combination of the configuration of the second exemplary embodiment, and the configuration of the third exemplary embodiment. The respective constituent elements of the fourth exemplary embodiment are the same as those of the first to third exemplary embodiments, and therefore, description thereof is omitted.

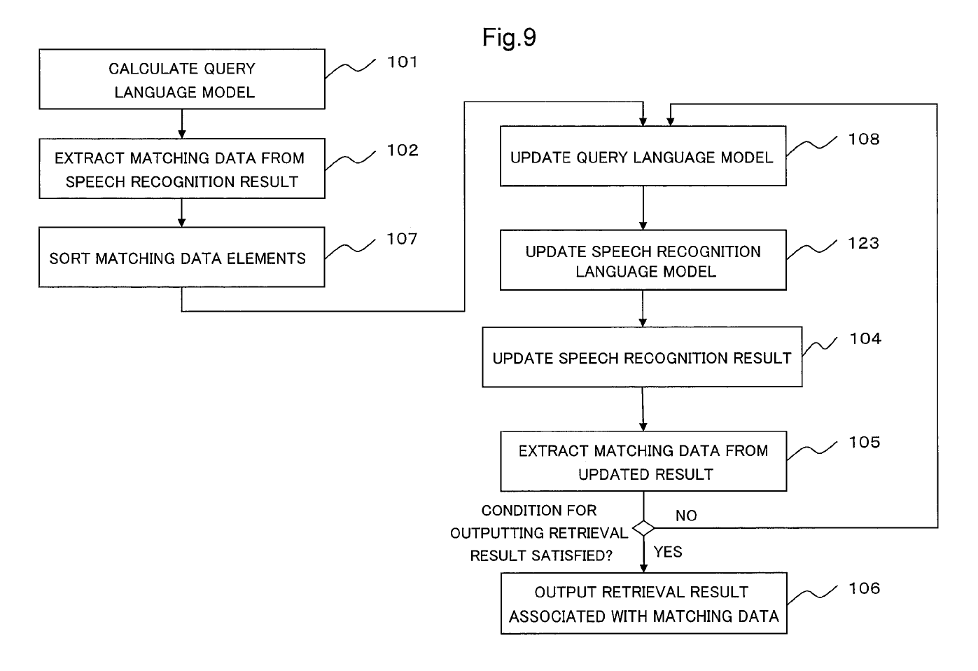

FIG. 9 is a flowchart illustrating an example of an operation of the fourth exemplary embodiment. The operations of Steps 101 to 108 are the same as those of the corresponding steps in the first to third exemplary embodiments, and therefore, description thereof is omitted.

According to the exemplary embodiment, it is possible to precisely retrieve data relating to speech.

### MODIFIED EXAMPLE

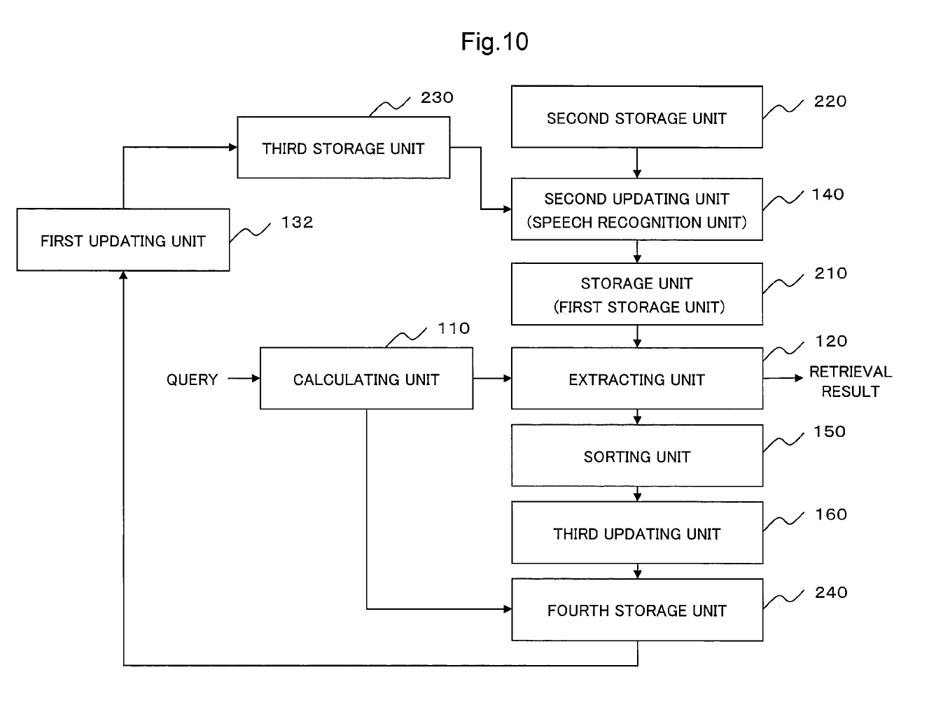

FIG. 10 is a block diagram illustrating a configuration of an information retrieval system according to a modified example of the fourth exemplary embodiment.

The information retrieval system according to the modified example includes a second storage unit 220, a third storage unit 230, and a fourth storage unit 240, in addition to the constituent elements of the fourth exemplary embodiment.

The second storage unit 220 stores speech data to be retrieved.

A second updating unit 140 is a unit for executing speech recognition. The second updating unit 140 speech-recognizes at least a part of speech data stored in the second storage unit 220, with use of a speech recognition language model stored in the speech recognition language model storage unit 230. Further, the second updating unit 140 stores a speech recognition result in a storage unit (first storage unit) 210.

The third storage unit 230 stores a speech recognition language model.

The fourth storage unit 240 stores a query language model.

A calculating unit 110 stores a calculated query language model in the fourth storage unit 240. Further, a third updating unit updates the query language model stored in the fourth storage unit 240. Furthermore, a first updating unit updates the speech recognition language model stored in the third storage unit 230, based on the updated query language model stored in the fourth storage unit 240.

The other constituent elements of the modified example are the same as those of the fourth exemplary embodiment, and therefore, description thereof is omitted.

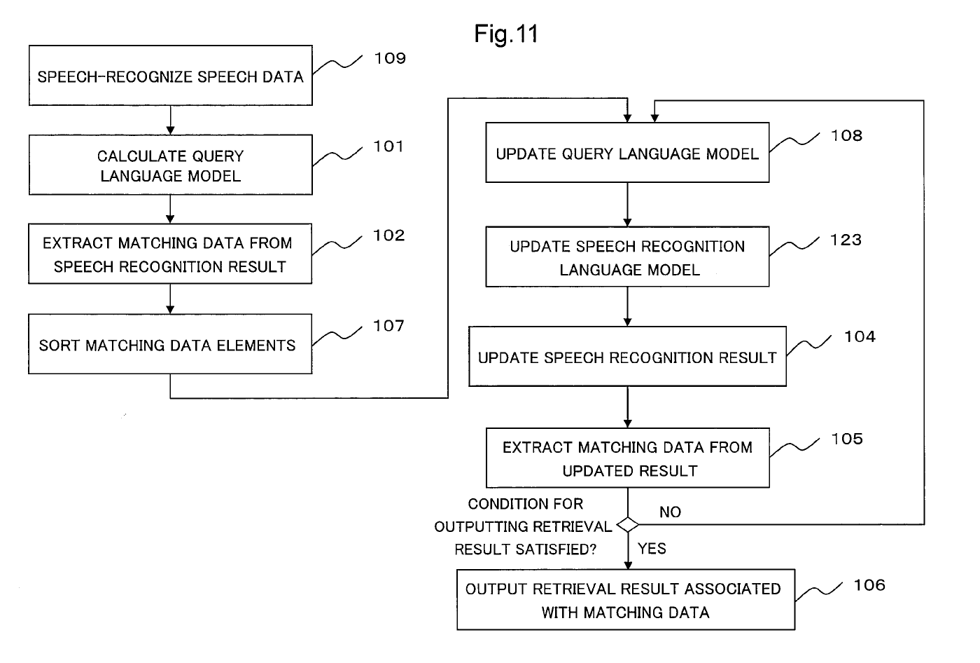

FIG. 11 is a flowchart illustrating an example of an operation of the modified example. In Step 109, the second updating unit 140 speech-recognizes at least a part of speech data stored in the second storage unit 220, with use of a speech recognition language model stored in the third storage unit 230. Subsequently, in Step 109, the second updating unit 140 stores a speech recognition result in the first storage unit 210. The operations of Steps 101 to 108 are the same as those of the corresponding steps in the first to fourth exemplary embodiments, and therefore, description thereof is omitted. Step 101 may be performed prior to Step 109.

In the flowcharts used in the foregoing description, a plurality of processes is described in order. The order of carrying out the processes to be implemented in each of the exemplary embodiments is not limited to the order as described above. In each of the exemplary embodiments, the order of the illustrated steps may be changed, as far as changing the order is not harmful to the contents. Further, it is possible to combine each of the exemplary embodiments and the modified example, as far as the contents are consistent.

As described above, the present invention has been described referring to the exemplary embodiments. The present invention, however, is not limited to the above exemplary embodiments. It is possible to add various modifications, which are comprehensible to a person skilled in the art, to the configuration and the details of the present invention within the scope of the invention.

(Note 1)

An information retrieval system including: a calculating unit which calculates a query language model that is a language model of an input word or of a set of input words; an extracting unit which refers to a storage means storing a result of speech recognition on speech data which is speech-recognized with use of a speech recognition language model, and extracting a result indicating a high degree of similarity to the query language model from the result, as matching data; a first updating unit which updates the speech recognition language model with use of the matching data; and a second updating unit which updates the result stored in the storage means, with use of the updated speech recognition language model, wherein the extracting means extracts a result indicating a high degree of similarity to the query language model from the updated result, and outputs a retrieval result indicating data associated with the extracted result.

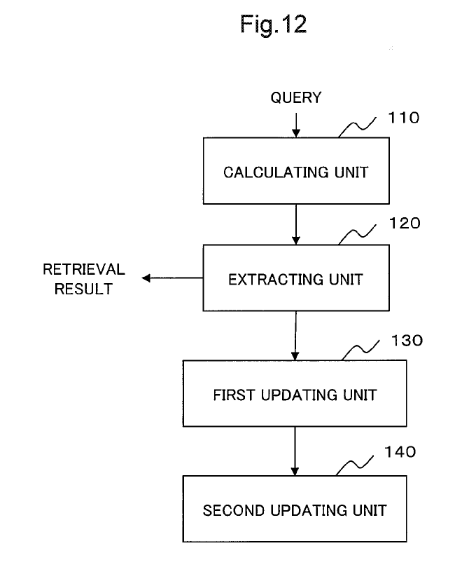

FIG. 12 is a block diagram illustrating a configuration of the information retrieval system of the invention.

(Note 2)

The information retrieval system according to Note 1, including:

a sorting unit which sorts matching data elements in a set of the matching data, based on a degree of similarity between the matching data elements, wherein the first updating means updates the speech recognition language model, with use of the sorted matching data elements.

(Note 3)

The information retrieval system according to Note 1 or 2, including: a third updating unit which updates the query language model with use of the matching data, wherein the first updating means updates the speech recognition language model, with use of the updated query language model, in place of using the matching data.

(Note 4)

The information retrieval system according to any one of Notes 1 to 3, wherein the extracting means outputs a retrieval result, when a result extracted from the updated result coincides with a result extracted from the result before updating.

(Note 5)

The information retrieval system according to any one of Notes 1 to 4, wherein the second updating means speech-recognizes the speech data with use of the updated speech recognition language model for updating the result.

(Note 6)

The information retrieval system according to any one of Notes 1 to 4, wherein the second updating means rescores a language probability of a word graph associated with the speech recognition result on the speech data, with use of the updated speech recognition language model for updating the result.

(Note 7)

An information retrieval method including: calculating a query language model that is a language model of an input word or of a set of input words; referring to a storage means storing a speech recognition result on speech data which is speech-recognized with use of a speech recognition language model, and extracting a result indicating a high degree of similarity to the query language model from the result, as matching data; updating the speech recognition language model with use of the matching data; updating the result stored in the storage means, with use of the updated speech recognition language model, and extracting a result indicating a high degree of similarity to the query language model from the updated result, and outputting a retrieval result indicating data associated with the extracted result.

(Note 8)

The information retrieval method according to Note 7, including: sorting matching data elements in a set of the matching data, based on a degree of similarity between the matching data elements, wherein the speech recognition language model is updated with use of the sorted matching data elements.

(Note 9)

A non-transitory computer-readable medium storing a program for an information retrieval system, which causes a computer to execute: calculating a query language model that is a language model of an input word or of a set of input words; referring to a storage means storing a speech recognition result on speech data which is speech-recognized with use of a speech recognition language model, and extracting a result indicating a high degree of similarity to the query language model from the result, as matching data; updating the speech recognition language model with use of the matching data; updating the result stored in the storage means, with use of the updated speech recognition language model; and extracting a result indicating a high degree of similarity to the query language model from the updated result, and outputting a retrieval result indicating data associated with the extracted result.

(Note 10)

The computer-readable medium according to Note 9, which causes the computer to execute: sorting matching data elements in a set of the matching data, based on a degree of similarity between the matching data elements, and updating the speech recognition language model with use of the sorted matching data elements.

### INDUSTRIAL APPLICABILITY

The invention is applicable to, for instance, a speech retrieval system capable of retrieving a part of speech data constituted of a recorded conversation or a recorded utterance, which is closely associated with a designated word or a designated word set.

This application claims the priority based on Japanese Patent Application No. 2012-214952 filed on Sep. 27, 2012, and the disclosure of which is hereby incorporated in its entirety.

### REFERENCE SIGNS LIST

1 Information retrieval system

10 CPU

12 Memory

14 HDD

16 Communication IF

18 Display device

20 Input device

22 Bus

110 Calculating unit

120 Extracting unit

130, 131, 132 First updating unit

140 Second updating unit

150 Sorting unit

160 Third updating unit

210 Storage unit (first storage unit)

220 Second storage unit

230 Third storage unit

240 Fourth storage unit

What is claimed is:

1. An information retrieval system comprising:
a calculating unit which calculates a query language model that is a language model of an input word or of a set of input words;
an extracting unit which refers to a storage means storing a result of speech recognition on speech data which is speech-recognized with use of a speech recognition language model, and extracting a result indicating a high degree of similarity to the query language model from the result, as matching data;
a first updating unit which updates the speech recognition language model with use of the matching data; and
a second updating unit which updates the result stored in the storage means, with use of the updated speech recognition language model, wherein
the extracting means extracts a result indicating a high degree of similarity to the query language model from the updated result, and outputs a retrieval result indicating data associated with the extracted result.

2. The information retrieval system according to claim 1, comprising:
a sorting unit which sorts matching data elements in a set of the matching data, based on a degree of similarity between the matching data elements, wherein
the first updating means updates the speech recognition language model, with use of the sorted matching data elements.

3. The information retrieval system according to claim 1 comprising:
a third updating unit which updates the query language model with use of the matching data, wherein
the first updating means updates the speech recognition language model, with use of the updated query language model, in place of using the matching data.

4. The information retrieval system according to claim 1, wherein
the extracting means outputs a retrieval result, when a result extracted from the updated result coincides with a result extracted from the result before updating.

5. The information retrieval system according to claim 1, wherein
the second updating means speech-recognizes the speech data with use of the updated speech recognition language model for updating the result.

6. The information retrieval system according to claim 1, wherein
the second updating means rescores a language probability of a word graph associated with the speech recognition result on the speech data, with use of the updated speech recognition language model for updating the result.

7. An information retrieval method comprising:
calculating a query language model that is a language model of an input word or of a set of input words;
referring to a storage means storing a speech recognition result on speech data which is speech-recognized with use of a speech recognition language model, and extracting a result indicating a high degree of similarity to the query language model from the result, as matching data;
updating the speech recognition language model with use of the matching data;
updating the result stored in the storage means, with use of the updated speech recognition language model, and
extracting a result indicating a high degree of similarity to the query language model from the updated result, and outputting a retrieval result indicating data associated with the extracted result.

8. The information retrieval method according to claim 7, comprising:
sorting matching data elements in a set of the matching data, based on a degree of similarity between the matching data elements, wherein
the speech recognition language model is updated with use of the sorted matching data elements.

9. A non-transitory computer-readable medium storing a program for an information retrieval system, which causes a computer to execute:
calculating a query language model that is a language model of an input word or of a set of input words;
referring to a storage means storing a speech recognition result on speech data which is speech-recognized with use of a speech recognition language model, and extracting a result indicating a high degree of similarity to the query language model from the result, as matching data;
updating the speech recognition language model with use of the matching data;
updating the result stored in the storage means, with use of the updated speech recognition language model; and
extracting a result indicating a high degree of similarity to the query language model from the updated result, and outputting a retrieval result indicating data associated with the extracted result.

10. The computer-readable medium according to claim 9, which causes the computer to execute:
sorting matching data elements in a set of the matching data, based on a degree of similarity between the matching data elements, and
updating the speech recognition language model with use of the sorted matching data elements.

11. An information retrieval system comprising:
a calculating unit which calculates a query language model that is a language model of an input word or of a set of input words;
an extracting unit which refers to a storage unit storing a result of speech recognition on speech data which is speech-recognized with use of a speech recognition language model, and extracts a result indicating a high degree of similarity to the query language model from the result, as matching data;
a first updating unit which updates the speech recognition language model with use of the matching data; and
a second updating units which updates the result stored in the storage unit, with use of the updated speech recognition language model, wherein
the extracting unit extracts a result indicating a high degree of similarity to the query language model from the updated result, and outputs a retrieval result indicating data associated with the extracted result.
